(19) United States
(12) Patent Application Publication
(10) Pub. No.: US 2002/0023586 A1
(43) Pub. Date: Feb. 28, 2002

(54) Electrostatic power coating system

(76) Inventor: Walter Jahn, Muensingen (CH)

Correspondence Address: CALFEE, HALTER & GRISWOLD, LLP, 800 SUPERIOR AVENUE, SUITE 1400, CLEVELAND, OH, 44114, US

(21) Appl. No.: 09/933,936

(22) Filed: Aug. 21, 2001

(30) Foreign Application Priority Data
Aug. 22, 2000 (EP) 00 810,747.6

(51) Int. Cl. B05B 5/025

(52) U.S. Cl. 118/630

(57) ABSTRACT

An electrostatic powder coating system that comprises a booth, the lower part of which is designed in the shape of a V, and a collecting channel (13), connected to a suction device (2) underneath, the booth having two ends, each of which has a pass-through opening for the workpieces. The collecting channel (13) is covered by floor plates (17), which can be walked upon or swung up into a vertical position, and which are provided with exhaust slots (18, 19, 20) extending in the longitudinal and transverse directions, it being advantageous for the total area of the slots be a function of the discharge of exhaust air and the velocity of the exhaust air.

The floor plates, which can be swung upward, improve the ability of the booth to be walked on and thus increase the ease with which the system can be serviced and operated. As a result of the way in which the exhaust slots are arranged, the powder residues can be extracted more homogeneously and uniformly and thus in optimum fashion over the entire length of the booth.

### PRIORITY CLAIM

This application claims the benefit of European Patent Application No. 00810747.6 filed on Aug. 22, 2000.

1. Field of the Invention

The present invention pertains to an electrostatic powder coating system according to the introductory clause of Claim 1.

2. Background of the Invention

A powder coating system of this type is known from, for example, EP-B 0,200,681. Whereas the shape of this known booth brought about a considerable improvement in the collection and exhaust of the powder residues in comparison with the state of the art at the time, it was discovered when systems of this type were built that it was necessary not only to improve the accessibility of these booths to their operators but also to increase the efficiency of the powder return.

A coating system is known from U.S. Pat. No. 6,010,571, in which the powder residues drop through grates onto two channels, each of which leads to a larger channel. A gully cover which is connected to a hinge joint is known from GB-A 2,120,303.

Against the background of this known state of the art, it is the task of the present invention to improve the accessibility of booths of the general type indicated above and to increase the efficiency of the powder return. This task is accomplished by means of an electrostatic powder system according to Claim 1.

The invention is explained in greater detail below on the basis of an exemplary embodiment, illustrated by drawings.

### DETAILED DESCRIPTION OF THE DRAWINGS

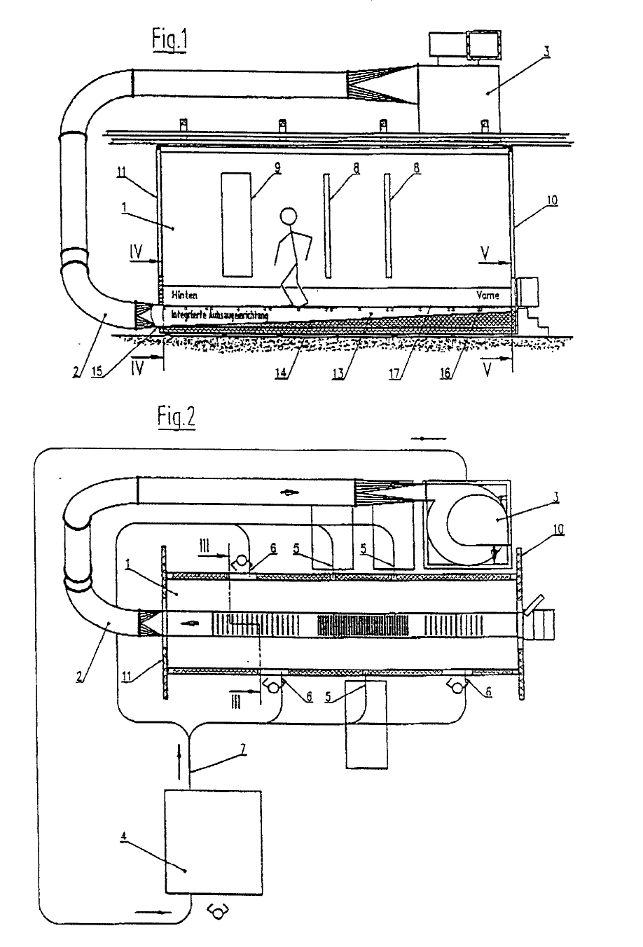

FIG. 1 shows a schematic diagram of a longitudinal section through a powder coating system according to the invention;

FIG. 2 is a sectional view of the system according to FIG. 1 from above;

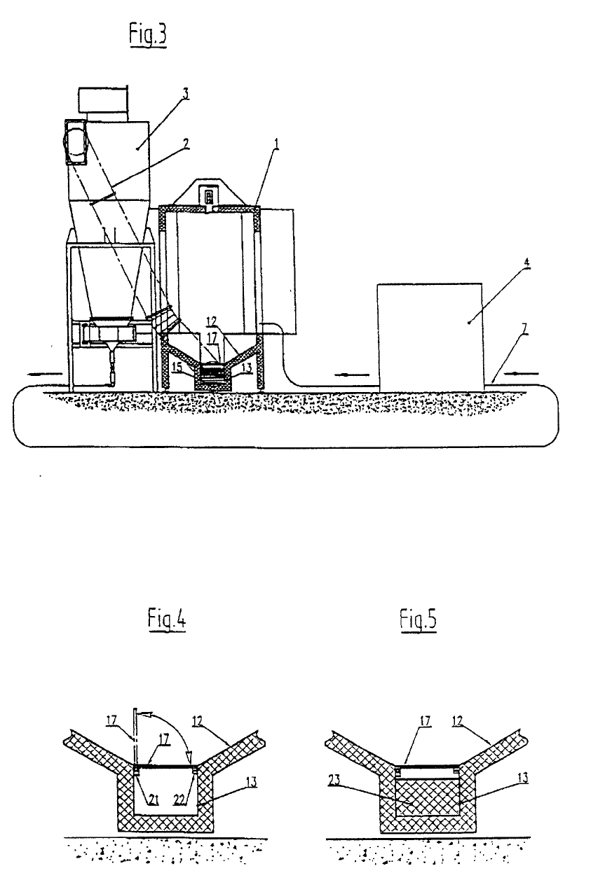

FIG. 3 is a sectional view along line III-III of FIG. 2;

FIG. 4 is a sectional view along line IV-IV of FIG. 1 on an enlarged scale;

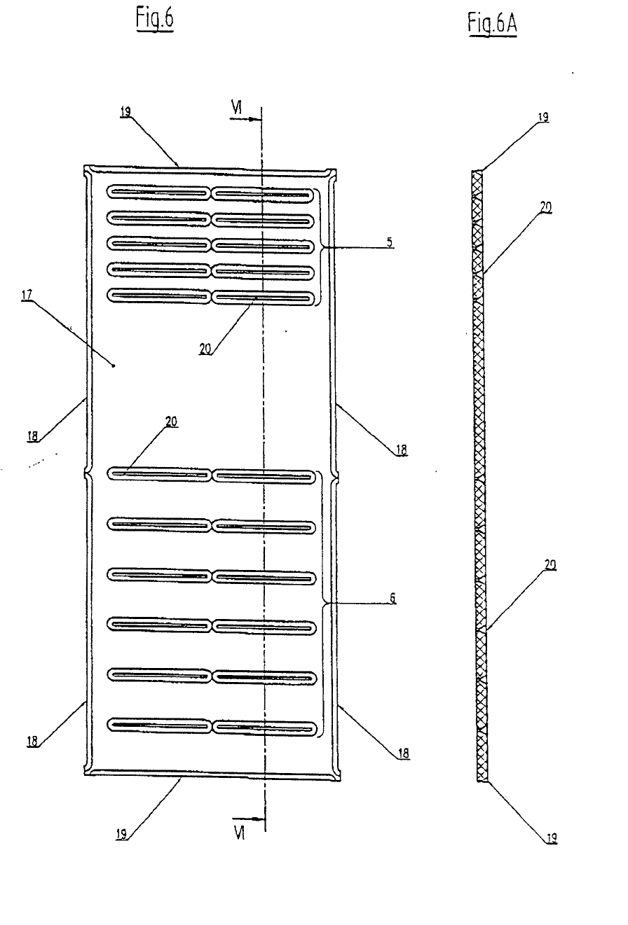

FIG. 5 is a sectional view along line V-V of FIG. 1 on an enlarged scale;

FIG. 6 is a top view of a floor plate of the system of FIG. 1; and

FIG. 7 is a sectional view along VI-VI of FIG. 6.

### DETAILED DESCRIPTION OF THE INVENTION

In the electrostatic powder coating system according to FIGS. 1-3, we can recognize the booth 1; the exhaust device with an exhaust pipe 2, which leads to the cyclone 3; and the powder tank 4, connected to the cyclone, from which the powder is sent via a powder line 7 to the automatic spray guns 5 or hand-operated devices 6. The exhaust device is also called an absolute filter or an afterfilter by experts in the field, because it contains filters.

The booth 1 can consist of electrically nonconductive material as indicated in the above-mentioned European patent and have a cleaning system identical or similar to that described in that patent. The coating elements, such as automatic hand-operated spray guns, are assumed as known, which also applies to the exhaust pipe, the cyclone, and the powder tank with the powder feed line and the line 7 between the cyclone and the powder tank. In the cross section of FIG. 1, we also see narrower and wider openings 8 and 9, respectively; the narrower openings 8 are provided for the automatic spray devices, which are mounted on a working platform, and the larger openings 9 are provided for manual preparation work or touch-up work by means of a hand-operated spray gun.

The ends 10, 11 of the booth can be designed as a gates with double doors providing an opening, as described in the patent cited above. It is also possible, however, for the booth to have merely pass-through openings for the workpieces; that is, the booth can be produced without movable parts such as gates.

As shown in FIG. 3, the booth has a V-shaped bottom part 12, to which the collecting channel 13 is connected underneath. In this exemplary embodiment, the channel has a rectangular cross section. As can be derived from the longitudinal cross section of FIG. 1, the channel floor 14 rises at a slant from the connection 15 of the exhaust pipe toward the front, so that, as a result, uniform suction power is obtained over the entire length of the booth. In the above-mentioned European patent, this same attempt was made by giving the suction channel a variable width, as seen from above, the channel becoming wider as it proceeds from the suction pipe toward the front, but this design did not prove suitable. It can be seen in FIG. 5 that the collecting channel 13 is closed off at the front by a plate 23 and also that the open height of the collecting channel at the front is considerably smaller than it is at the connection between the channel and the suction pipe (see FIG. 4).

The collecting channel 13 is closed off by floor plates 17, supported along the length by holders 16, as can be seen in FIGS. 1 and 2. FIGS. 6 and 6A show a floor plate 17 in a view from above and in cross section. This floor plate is made out of a suitable, electrically nonconductive plastic material and can, for example, have a length of 1,200 mm, a width of 500 mm, and a thickness of 20 mm. Depending on the system, the floor plates can also have other dimensions and be made of some other material. The walkable floor plates are designed to be stable enough that they can support the weight of worker; the indicated dimensions easily fulfill this requirement.

To guarantee that the powder residues, which are not distributed uniformly over the entire floor of the booth but which are rather more concentrated in the area of the automatic spray guns and less concentrated in the area of the manual preparation and touch-up work, are exhausted with maximum efficiency, various slots and slot arrangements are provided in the floor plate or plates. Thus, for example, one floor plate has slots 18 along both longitudinal sides and intermediate slots 19 along both transverse sides, and additional transverse slots 20 in the interior of the floor plate. The transverse slots 20 are not distributed uniformly over the plate or distributed uniformly over several plates but rather are more concentrated in the areas 5 of the automatic spray guns and less concentrated in the areas 6 of manual processing.

The longitudinal slots 18 play a greater role in homogeneous extraction over the entire length of the booth than the transverse slots 19, 20, which can also be arranged at an angle to the longitudinal axis. In addition, especially in the case of smaller booths, the transverse or slanted slots can be replaced by just a few openings or possibly by one opening in a plate or in several plates.

In regard to the layout of the slots, i.e., their frequency and width, it is advantageous to design them in such a way that the total open surface area of the slots results in a velocity of the exhaust air flow produced by the afterfilter, which makes maximum powder return possible. At a desired flow velocity of 16 m/s and a discharge of exhaust air of 4.444 m³/s, a total open surface area for the slots of 0.278 m² is obtained. That means that, by means of a simplified calculation, the discharge of exhaust air in m³/s, divided by the desired, optimum flow velocity in m/s, gives the desired total area of the slots of one web.

An exhaust slot arrangement on a floor plate of this type and the arrangement of the floor plates according to FIGS. 1 and 2 make possible a homogeneous, uniform, and optimum exhaust of the powder residues over the entire length of the booth during operation, this being accomplished at high exhaust outputs.

To clean the collecting channel, the floor plates must be removed. According to FIG. 4, it is possible to swing the floor plate up into a vertical position and to hold it in this vertical position by means of the retaining part 21 of the holder 16. It is also possible to remove the plate entirely. In the folded-down state, it rests on the support part 22. It is also possible to attach hinges at the locations of the retaining parts.

Although one embodiment of this invention has been shown and described, various adaptations and modifications can be made without departing from the scope of the invention as defined in the appended claims.

I claim:

1. An electrostatic powder coating system comprising a booth, designed with a V-shaped lower part, and a collecting channel connected to an exhaust device underneath, and which is provided with two ends, each of which has a pass-through opening for the workpieces, characterized in that the collecting channel is covered by at least one walkable floor plate, which can be raised into a vertical position, the floor plate being provided with exhaust slots arranged at least along both long sides and with at least one exhaust opening or an exhaust slot in the interior of the floor plate, it also being possible for the floor plate to be swung up and held in a vertical position.

2. The system according to claim 1, characterized in that the total area of the slots and openings in the floor plate(s) is a function of the flow velocity of the exhaust air and the discharge of exhaust air, where the discharge of exhaust air in m³/s, divided by the flow velocity in m/s, gives the total open area in m².

3. The system according to claim 1, characterized in that the floor plate(s) can be removed or swung up and held in place in any position.

4. The system according to claims 1, characterized in that the floor plate(s) is/are provided with longitudinal exhaust slots along both long sides, with transverse intermediate slots along both transverse sides, and additional transverse or slanted exhaust slots, which are arranged more or less closely together according to where the powder collects in greater or lesser concentrations.

5. System according to claims 1, characterized in that the height of the collecting channel floor, seen in longitudinal cross section, decreases as it extends away from the connection of the exhaust pipe.

6. A powder spray system comprising:
a spray booth having a V-shaped bottom part connected to a collecting channel;
said collecting channel having a channel floor rising from the first rend of the spray booth to a second end of the spray booth.

7. The powder spray system of claim 6 wherein said first end of said spray booth is connected to an exhaust pipe.

8. The powder spray system of claim 6 further comprising one or more floor plates comprising one or more slots.

9. The powder spray system of claim 8 wherein said slots are transversely located.

10. The powder spray system of claim 8 wherein said slots are located upon a longitudinal side of said floor plates.

11. The powder spray system of claim 9 wherein said transverse slots are arranged at an angle to the longitudinal axis.

12. The powder spray system of claim 8 wherein said slots have a total surface area determined by the exhaust air discharge divided by the optimum flow velocity.

13. The powder spray system of claim 8 wherein said floor plates further comprise a hinge.
